(19) United States
(12) Patent Application Publication
(10) Pub. No.: US 2023/0152820 A1
(43) Pub. Date: May 18, 2023

(54) AUTOMATED GUIDED VEHICLE SCHEDULING METHOD, ELECTRONIC DEVICE AND COMPUTER-READABLE STORAGE MEDIUM

(71) Applicant: Nanning FuLian FuGui Precision Industrial Co., Ltd., Nanning (CN)

(72) Inventors: TAO-NIAN HUANG, Nanning (CN); LIU-LING WANG, Nanning (CN)

(21) Appl. No.: 17/536,335

(22) Filed: Nov. 29, 2021

(30) Foreign Application Priority Data
Nov. 16, 2021 (CN) 202111356499.6

(51) Int. Cl. G05D 1/02; G05D 1/00; B60W 60/00; B60W 50/02

(52) U.S. Cl. CPC G05D 1/0287; B60W 50/0225; B60W 60/001; G05D 1/0088; G05D 1/0214

(57) ABSTRACT

An automated guided vehicle (AGV) scheduling method is disclosed. All the possible paths of the current AGV are calculated using the A* search algorithm. Time windows information tables are calculated according to shortest paths. Time windows of executed tasks are compared to find optimal paths. Types of conflicts are determined and priorities of the AGVs are modified and the time window information tables are updated according to the comparison result. When an obstacle is detected or the current AGV is malfunctioning, abnormal issues are dynamically processed and the time window information tables of the tasks are modified as the current AGV reaches a target workstation.

### BACKGROUND

### 1. Technical Field

The disclosure relates to network connection methods, and more particularly to an automated guided vehicle scheduling method based on time windows for an electronic device and a computer program product using the method.

### 2. Description of Related Art

A known automated guided vehicle scheduling method calculates all feasible paths through the A* search algorithm, traverses all the feasible paths in turn, and establishes time window models for the paths. Under the premise of keeping the time window of the original task unchanged, the time window of the current task is planned in real time, and the path with the shortest duration is selected as the optimal path from the traversed paths.

However, the above-mentioned automated guided vehicle scheduling method sequentially traverses all the feasible paths and establishes the time window models of the paths, which is time-consuming and reduces timeliness. Additionally, the event that the time window of the current task is planned in real time under the premise of keeping the time window of the original task unchanged only plans the time window of the current task without dynamically changing the time windows of all the tasks, resulting in decreasing the flexibility of the AGV scheduling.

### BRIEF DESCRIPTION OF THE DRAWINGS

Many aspects of the preset disclosure can be better understood with reference to the following figures. The components in the figures are not necessarily drawn to scale, the emphasis instead being placed upon clearly illustrating the principles of the preset disclosure. Moreover, in the drawings, like reference numerals designate corresponding parts throughout the several views. Implementations of the preset technology will now be described, by way of embodiments, with reference to the attached figures, wherein:

FIG. 1 is a schematic diagram of an embodiment of an automated guided vehicle (AGV) scheduling method of the preset disclosure;

FIGS. 2A-2C are flowcharts of an embodiment of an AGV scheduling method of the preset disclosure;

FIG. 3 is a schematic diagram of an embodiment of optimal paths of AGVs of the preset disclosure;

FIG. 4 is a schematic diagram of an embodiment of a time window for AGVs of the preset disclosure;

FIG. 5 is a block diagram of an embodiment of the hardware architecture of an electronic device using the method of the preset disclosure; and

FIG. 6 is a schematic diagram of functional blocks of the electronic device using the method according to an embodiment of the preset disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the preset disclosure.

Several definitions that apply throughout this disclosure will now be preseted.

The term “comprising,” when utilized, means “including, but not necessarily limited to”; it specifically indicates open-ended inclusion or membership in the so-described combination, group, series, and the like.

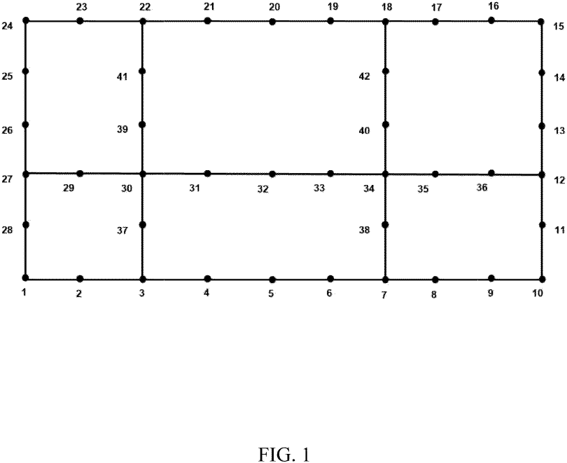

FIG. 1 is a schematic diagram of an embodiment of an automated guided vehicle (AGV) scheduling method of the preset disclosure. Paths and nodes are planned on a system map, and a grid path map is created with same paths as an actual site. As shown in FIG. 1, nodes 1-42 are assigned with corresponding coordinate parameters and line segments between the nodes are bidirectional. Each of the line segments is 5 meters. Supposed that there are 5 AGVs with a speed 0.5 m/s, they are represented as: (1) AGV1: moving from the node 28 to the node 40; (2) AGV2: moving from the node 26 to the node 37; (3) AGV3: moving from the node 17 to the node 33; (4) AGV4: moving from the node 9 to the node 42; and (5) AGV5: moving from the node 4 to the node 41.

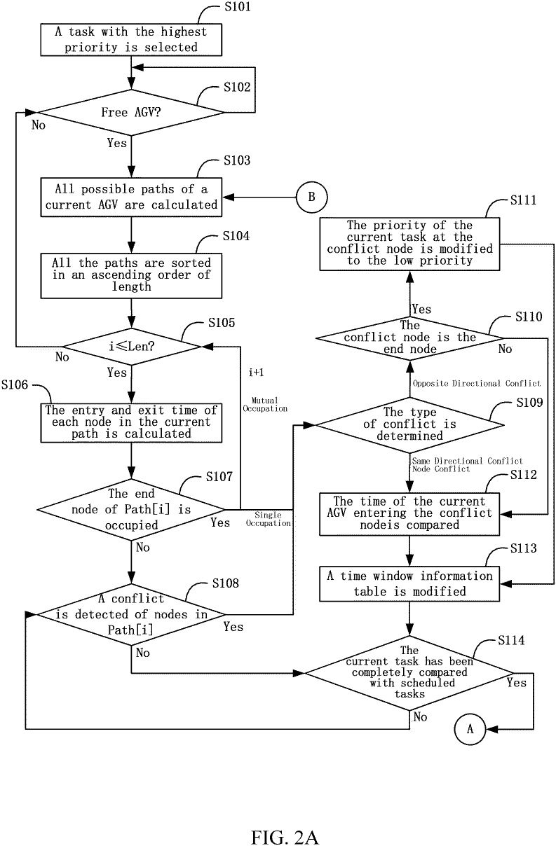

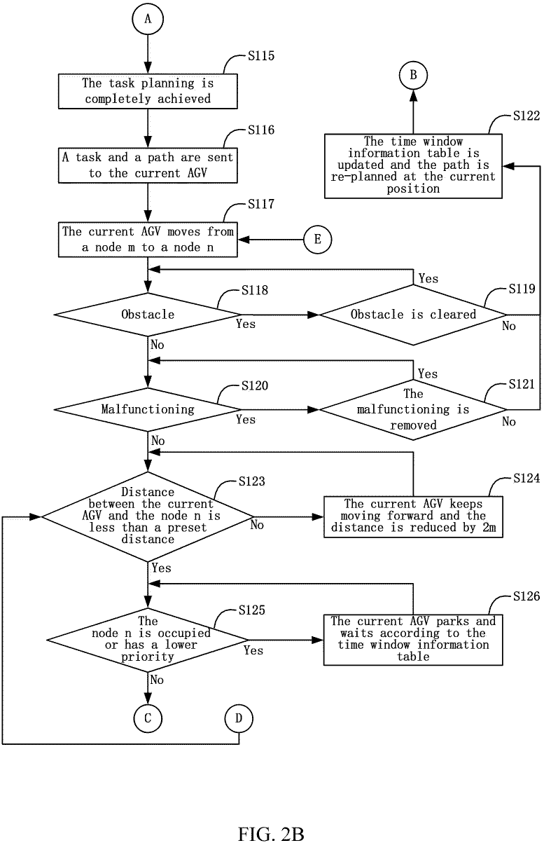

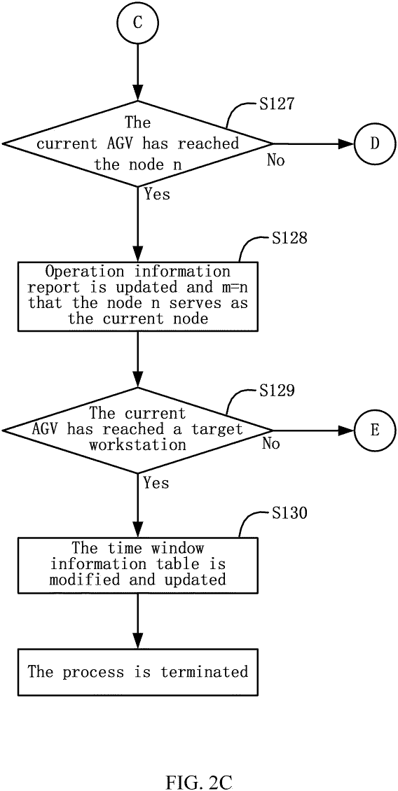

FIGS. 2A-2C are flowcharts of an embodiment of an AGV scheduling method, applied in an electronic device, of the preset disclosure. The order of the steps in the flowchart can be changed and some steps can be omitted according to different requirements.

In block S101, multiple tasks are prioritized and a task with the highest priority is selected as the current task.

In block S102, it is checked if there is a free AGV. If there is no a free AGV, the process proceeds to the step S101 to select another task with the highest priority as the current task.

In block S103, if there is no a free AGV, for example, AGV1, the A^{∗} search algorithm is used to calculate all possible paths of a current AGV, for example, the AGV1, that obtains Path[Len] and a variable i is initialized as 1 (i=1). The variable Len represents the number of calculated paths, i=1 to Len.

In block S104, all the paths are sorted in an ascending order of length.

In block S105, it is determined whether the variable i is smaller than or equal to Len. If the variable i is not smaller than or equal to Len, the process proceeds to the step S102 to check if there is another free AGV.

In block S106, if the variable i is smaller than or equal to Len, i+1 and the entry and exit time of each node in the current (i-th) path is calculated.

In block S107, compared with the previous task, it is determined whether the end node of the current path (Path[Len]) is occupied, for example, single occupation or mutual occupation. If the end node of the current path is occupied with the mutual occupation, i+1 and the process proceeds to the step S105.

In block S108, if the end node of the current path is not occupied, it is determined whether a conflict is detected between other nodes in the current path and the nodes of the previous task.

In block S109, if the conflict is detected or the end node of the current path is occupied with the single occupation in the step S107, the type of the conflict is determined.

The types of conflict include the node conflict, the same directional conflict and the opposite directional conflict.

The node conflict means that when both AGV1 and AGV2 pass through the same node with a time conflict, they collide on the same node.

The same directional conflict means that both AGV1 and AGV2 go through the same path and travel in the same direction and, when their travel speeds are different, a rear-end collision may occur.

The opposite directional conflict means that both AGV1 and AGV2 go through the same path and travel in opposite directions and, if there is a time conflict, a collision may occur.

In block S110, if the mutual direction conflict is detected, it is determined whether the conflict node is the end node.

In block S111, if the conflict node is the end node, the priority of the current task at the conflict node is modified to the low priority.

In block S112, if the same direction conflict or the node conflict is detected, or the conflict node is not the end node at the step S110, the time of the current AGV entering the conflict node in the previous task is compared with the time of the current AGV entering the conflict node in the current task to assign priorities.

In block S113, after the priorities are assigned or the priority of the current task at the conflict node is modified to the low priority in the step S111, a time window information table is modified.

In block S114, as the time window information table is modified, or no conflict is detected in step S108, it is determined whether the current task has been completely compared with scheduled tasks. If the current task has not been completely compared with the scheduled tasks, the process proceeds to the step S108.

In block S115, if the current task has been completely compared with the scheduled tasks, the task planning is completely achieved.

In block S116, a task and a path are sent to the current AGV.

In block S117, the current AGV moves from a node m to the next node n when the task and the path are received.

In block S118, it is determined whether there is an obstacle between the node m and the node n.

In block S119, if there is an obstacle between the node m and the node n, the current AGV stops and waits for a preset time, for example, 5 seconds, and it is determined whether the obstacle is cleared. If the obstacle is cleared, the process proceeds to the step S118.

In block S120, if there is no obstacle between the node m and the node n, it is determined whether the current AGV is malfunctioning.

In block S121, if the current AGV is malfunctioning, the current AGV stops and waits for the preset time, for example, 5 seconds, and it is determined whether the malfunctioning state is removed. If the malfunctioning state is removed, the process proceeds to the step S120.

In block S122, if the obstacle is not cleared in the step S119, or if the malfunctioning state is not removed in the step S121, the time window information table is updated and the path is re-planned at the current position, and the process proceeds to the step S103.

In block S123, if the current AGV is not malfunctioning, it is determined whether a distance between the current AGV and the node n is less than a preset distance, for example, 2 meters.

In block S124, if the distance between the current AGV and the node n is not less than the preset distance, the current AGV keeps moving forward and the distance between the current position and the node n is reduced by 2 meters, and the process proceeds to the step S123.

In block S125, if the distance between the current AGV and the node n is less than the preset distance, it is determined whether the node n is occupied or has a lower priority.

In block S126, if the node n is occupied or has a lower priority, the current AGV parks and waits according to the time window information table, and the process proceeds to the step S125.

In block S127, if the node n is not occupied or does not have a lower priority, the current AGV keeps moving forward and it is determined whether the current AGV has reached the node n. If the current AGV has not reached the node n, the process proceeds to the step S123.

In block S128, if the current AGV has reached the node n, operation information report is updated and m=n that the node n serves as the current node.

In block S129, it is determined whether the current AGV has reached a target workstation. If the current AGV has not reached the target workstation, the process proceeds to the step S117.

In block S130, if the current AGV has reached the target workstation, the time window information table is modified and updated and the process is terminated.

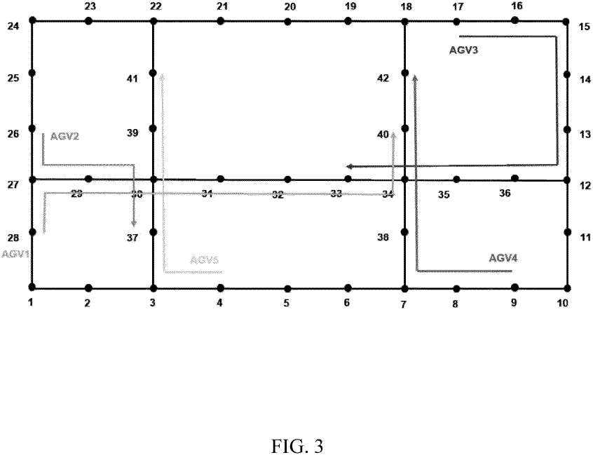

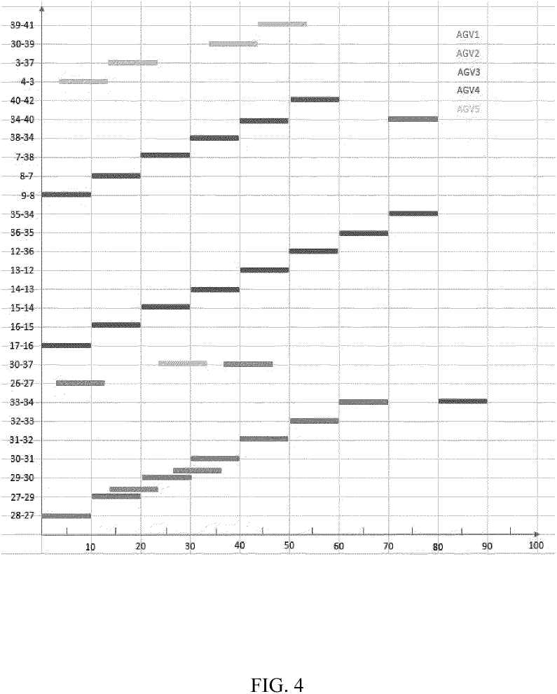

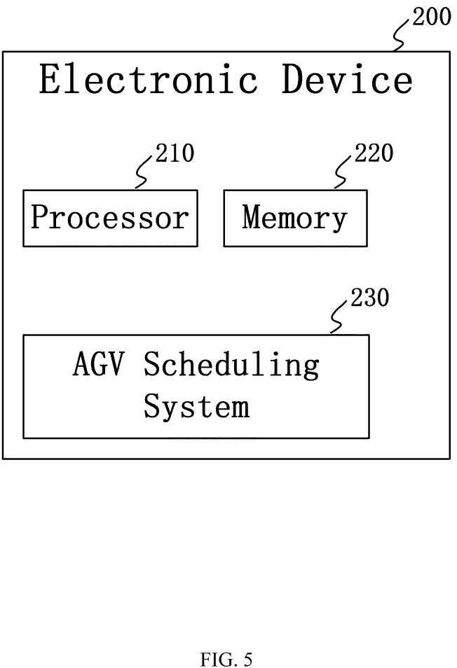

As the embodiment of the AGV scheduling method based on time windows is applied, 5 tasks are assigned to 5 AGVs, optimal paths of the 5 AGVs are generated as shown in FIG. 3, and the time window for the optimal paths is shown in FIG. 5.

The embodiment of the AGV scheduling method based on time windows of the present disclosure calculates all possible available paths of AGVs, calculates time windows based on the shortest paths of the AGVs, and compared time information tables of executed tasks to find optimal paths, which reduces computational complexity and improves timeliness.

FIG. 5 is a block diagram of an embodiment of the hardware architecture of an electronic device using the automated guided vehicle scheduling method of the preset disclosure. The electronic device 200 may, but is not limited to, connect to a processor 210, a memory 220, and an automated guided vehicle scheduling system 230 via system buses. The electronic device 200 shown in FIG. 5 may include more or fewer components than those illustrated, or may combine certain components.

The memory 220 stores a computer program, such as the automated guided vehicle scheduling system 230, which is executable by the processor 210. When the processor 210 executes the automated guided vehicle scheduling system 230, the blocks in one embodiment of the automated guided vehicle scheduling method applied in the electronic device 200 are implemented, such as blocks S110 to S130 shown in FIGS. 2A-2C.

It will be understood by those skilled in the art that FIG. 5 is merely an example of the electronic device 200 and does not constitute a limitation to the electronic device 200. The electronic device 200 may include more or fewer components than those illustrated, or may combine certain components. The electronic device 200 may also include input and output devices, network access devices, buses, and the like.

The processor 210 may be a central processing unit (CPU),or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the automated guided vehicle scheduling system 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or other volatile solid state storage device.

The automated guided vehicle scheduling system 230 can be partitioned into one or more modules/units that are stored in the memory 220 and executed by the processor 210. The one or more modules/units may be a series of computer program instructions capable of performing particular functions of the automated guided vehicle scheduling system 230.

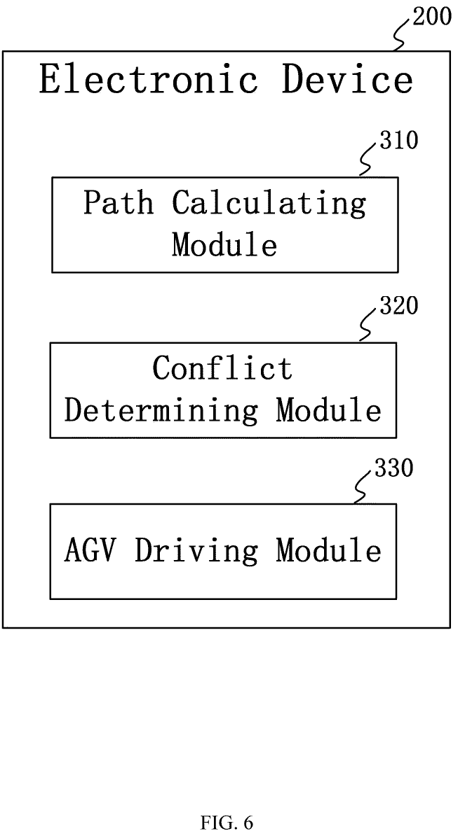

FIG. 6 is a schematic diagram of an embodiment of functional blocks of the electronic device using the method of the preset disclosure.

The electronic device 200, such as a mobile device, comprises a path calculating module 310, a conflict determining module 320 and an AGV driving module 330.

The path calculating module 310 prioritizes multiple tasks and selects a task with the highest priority as the current task.

The path calculating module 310 checks if there is a free AGV. If there is no a free AGV, another task with the highest priority is selected as the current task.

In block S103, if there is a free AGV, for example, AGV1, the path calculating module 310 calculates all possible paths of a current AGV, for example, the AGV1, using the A* search algorithm, that obtains Path[Len] and a variable i is initialized as 1 (i=1). The variable Len represents the number of calculated paths, i=1 to Len.

The path calculating module 310 sorts all the paths in an ascending order of length.

The path calculating module 310 determines whether the variable i is smaller than or equal to Len. If i is not smaller than or equal to Len, it is checked if there is another free AGV.

If i is smaller than or equal to Len, i+1 and the path calculating module 310 calculates the entry and exit time of each node in the current (i-th) path.

Compared with the previous task, the conflict determining module 320 determines whether the end node of the current path (Path[Len]) is occupied, for example, single occupation or mutual occupation. If the end node of the current path is occupied with the mutual occupation, i+1.

If the end node of the current path is not occupied, the conflict determining module 320 determines whether a conflict is detected between other nodes in the current path and the nodes of the previous task.

If the conflict is detected or the end node of the current path is occupied with the single occupation, the conflict determining module 320 determine the type of the conflict.

The types of conflict include the node conflict, the same directional conflict and the opposite directional conflict.

The node conflict means that when both AGV1 and AGV2 pass through the same node with a time conflict, they collide on the same node.

The same directional conflict means that both AGV1 and AGV2 go through the same path and travel in the same direction and, when their travel speeds are different, a rear-end collision may occur.

The opposite directional conflict means that both AGV1 and AGV2 go through the same path and travel in opposite directions and, if there is a time conflict, a collision may occur.

If the mutual direction conflict is detected, the conflict determining module 320 determines whether the conflict node is the end node.

If the conflict node is the end node, the conflict determining module 320 modifies the priority of the current task at the conflict node to low priority.

If the same direction conflict or the node conflict is detected, or the conflict node is not the end node, the conflict determining module 320 compares the time of the current AGV entering the conflict node in the previous task with the time of the current AGV entering the conflict node in the current task to assign priorities.

After the priorities are assigned or the priority of the current task at the conflict node is modified to the low priority, the conflict determining module 320 modifies a time window information table.

As the time window information table is modified, or no conflict is detected, the conflict determining module 320 determines whether the current task has been completely compared with scheduled tasks.

If the current task has been completely compared with the scheduled tasks, indicating that the task planning is completely achieved, the AGV driving module 330 sends a task and a path to the current AGV.

The AGV driving module 330 drives the current AGV to move from a node m to the next node n when the task and the path are received.

The AGV driving module 330 determines whether there is an obstacle between the node m and the node n.

If there is an obstacle between the node m and the node n, the AGV driving module 330 enables the current AGV to stop and wait for a preset time, for example, 5 seconds, and determines whether the obstacle is cleared.

If there is no obstacle between the node m and the node n, the AGV driving module 330 determines whether the current AGV is malfunctioning.

If the current AGV is malfunctioning, the AGV driving module 330 enables the current AGV to stop and wait for the preset time, for example, 5 seconds, and determines whether the malfunctioning state is removed.

If the obstacle has not cleared, or if the malfunctioning state has not removed, the AGV driving module 330 updates the time window information table and re-plans the path at the current position.

If the current AGV is not malfunctioning, the AGV driving module 330 determines whether a distance between the current AGV and the node n is less than a preset distance, for example, 2 meters.

If the distance between the current AGV and the node n is not less than the preset distance, the AGV driving module 330 enables the current AGV to keep moving forward and reduce the distance between the current position and the node n by 2 meters.

If the distance between the current AGV and the node n is less than the preset distance, the AGV driving module 330 determines whether the node n is occupied or has a lower priority.

If the node n is occupied or has a lower priority, the AGV driving module 330 enables the current AGV to park and wait according to the time window information table.

If the node n is not occupied or does not have a lower priority, the AGV driving module 330 enables the current AGV to keep moving forward and determines whether the current AGV has reached the node n.

If the current AGV has reached the node n, the AGV driving module 330 updates operation information report and enables m=n that the node n serves as the current node.

The AGV driving module 330 determines whether the current AGV has reached a target workstation.

If the current AGV has reached the target workstation, the AGV driving module 330 modifies and updates the time window information table and the process is terminated.

It is to be understood, however, that even though numerous characteristics and advantages of the preset disclosure have been set forth in the foregoing description, together with details of the structure and function of the preset disclosure, the disclosure is illustrative only, and changes may be made in detail, especially in matters of shape, size, and arrangement of parts within the principles of the preset disclosure to the full extent indicated by the broad general meaning of the terms in which the appended claims are expressed.

What is claimed is:

1. An automated guided vehicle (AGV) scheduling method executable by an electronic device, comprising:
prioritizing multiple tasks and selecting a task with the highest priority as a current task;
selecting a free AGV as a current AGV;
calculating all possible paths of the current AGV;
selecting one of the paths as a current path and calculating the entry and exit time of each node in the current path;
comparing with the previous task, determining whether the end node of the current path is occupied;
if the end node of the current path is not occupied, determining whether a conflict is detected between other nodes in the current path and the nodes of the previous task;
if the conflict is detected or the end node of the current path is occupied with single occupation, determining the type of the conflict;
if the type of the conflict is a mutual direction conflict, determining whether the conflict node is the end node;
if the conflict node is the end node, modifying the priority of the current task at the conflict node to low priority.
if the type of the conflict is a same mutual direction conflict or a node conflict, or the conflict node is not the end node, comparing the time of the current AGV entering the conflict node in the previous task with the time of the current AGV entering the conflict node in the current task to assign priorities;
after the priorities are assigned or the priority of the current task at the conflict node is modified to the low priority, modifying a time window information table;
as the time window information table is modified, or no conflict is detected, determining whether the current task has been completely compared with scheduled tasks; and
if the current task has been completely compared with the scheduled tasks, driving the current AGV to perform the current task.

2. The method of claim 1, wherein the step of driving the current AGV to perform the current task further comprises:
driving the current AGV to move from a node m to the next node n;
determining whether there is an obstacle between the node m the and the node n;
if there is an obstacle between the node m and the node n, enabling the current AGV to stop and wait for a preset time, and determining whether the obstacle is cleared;
if there is no obstacle between the node m and the node n, determining whether the current AGV is malfunctioning;
if the current AGV is malfunctioning, enabling the current AGV to stop and wait for the preset time, and determining whether the malfunctioning state is removed; and
if the obstacle is not cleared, or if the malfunctioning state is not removed, updating the time window information table and re-planning the path at a current position of the current AGV.

3. The method of claim 2, wherein the step of driving the current AGV to perform the current task further comprises:
if the current AGV is not malfunctioning, determining whether a distance between the current AGV and the node n is less than a preset distance;
if the distance between the current AGV and the node n is not less than the preset distance, enabling the current AGV to keep moving forward and reducing the distance between the current position and the node n by a second preset distance;
if the distance between the current AGV and the node n is less than the preset distance, determining whether the node n is occupied or has a lower priority;
if the node n is occupied or has a lower priority, enabling the current AGV to park and wait according to the time window information table;
if the node n is not occupied or does not have a lower priority, enabling the current AGV to keep moving forward and determining whether the current AGV has reached the node n;
if the current AGV has reached the node n, updating operation information report and m=n that the node n serves as the current node;
determining whether the current AGV has reached a target workstation; and
if the current AGV has reached the target workstation, modifying and updating the time window information table and terminating the current task.

4. The method of claim 1, further comprising:
if the end node of the current path is occupied with mutual occupation, selecting another path from the paths as the current path.

5. The method of claim 1, further comprising:
calculating all the possible paths of the current AGV using the A* search algorithm.

6. A electronic device, comprising:
a path calculating module, configured to prioritize multiple tasks and select a task with the highest priority as a current task, select a free AGV as a current AGV, calculate all possible paths of the current AGV, select one of the paths as a current path and calculate the entry and exit time of each node in the current path, and, compared with the previous task, determine whether the end node of the current path is occupied;
a conflict determining module, configured to, if the end node of the current path is not occupied, determine whether a conflict is detected between other nodes in the current path and the nodes of the previous task, if the conflict is detected or the end node of the current path is occupied with single occupation, determine the type of the conflict, if the type of the conflict is a mutual direction conflict, determine whether the conflict node is the end node, if the conflict node is the end node, modify the priority of the current task at the conflict node to low priority, if the type of the conflict is a same mutual direction conflict or a node conflict, or the conflict node is not the end node, compare the time of the current AGV entering the conflict node in the previous task with the time of the current AGV entering the conflict node in the current task to assign priorities, after the priorities are assigned or the priority of the current task at the conflict node is modified to the low priority, modify a time window information table, and, as the time window information table is modified, or no conflict is detected, determine whether the current task has been completely compared with scheduled tasks; and
an AGV driving module, configured to, if the current task has been completely compared with the scheduled tasks, drive the current AGV to perform the current task.

7. The electronic device of claim 6, wherein the AGV driving module is further configured to drive the current AGV to move from a node m to the next node n, determine whether there is an obstacle between the node m the and the node n, if there is an obstacle between the node m and the node n, enable the current AGV to stop and wait for a preset time, and determining whether the obstacle is cleared, if there is no obstacle between the node m and the node n, determine whether the current AGV is malfunctioning, if the current AGV is malfunctioning, enable the current AGV to stop and wait for the preset time and determine whether the malfunctioning state is removed, and, if the obstacle is not cleared, or if the malfunctioning state is not removed, update the time window information table and re-plan the path at a current position of the current AGV.

8. The electronic device of claim 7, wherein the AGV driving module is further configured to, if the current AGV is not malfunctioning, determine whether a distance between the current AGV and the node n is less than a preset distance, if the distance between the current AGV and the node n is not less than the preset distance, enable the current AGV to keep moving forward and reduce the distance between the current position and the node n by a second preset distance, if the distance between the current AGV and the node n is less than the preset distance, determine whether the node n is occupied or has a lower priority, if the node n is occupied or has a lower priority, enable the current AGV to park and wait according to the time window information table, if the node n is not occupied or does not have a lower priority, enable the current AGV to keep moving forward and determine whether the current AGV has reached the node n, if the current AGV has reached the node n, update operation information report and m=n that the node n serves as the current node, determine whether the current AGV has reached a target workstation, and, if the current AGV has reached the target workstation, modify and update the time window information table and terminate the current task.

9. The electronic device of claim 6, wherein the path calculating module, if the end node of the current path is occupied with mutual occupation, selects another path from the paths as the current path.

10. The electronic device of claim 6, wherein the path calculating module calculate all the possible paths of the current AGV using the A* search algorithm.

11. A non-transitory computer-readable storage medium, storing computer program which causes a computer to execute:
a process of prioritize multiple tasks and select a task with the highest priority as a current task;
a process of selecting a free AGV as a current AGV;
a process of calculating all possible paths of the current AGV;
a process of selecting one of the paths as a current path and calculating the entry and exit time of each node in the current path;
a process of comparing with the previous task, determining whether the end node of the current path is occupied;
a process of, if the end node of the current path is not occupied, determining whether a conflict is detected between other nodes in the current path and the nodes of the previous task;
a process of, if the conflict is detected or the end node of the current path is occupied with single occupation, determining the type of the conflict;
a process of, if the type of the conflict is a mutual direction conflict, determining whether the conflict node is the end node;
a process of, if the conflict node is the end node, modifying the priority of the current task at the conflict node to low priority.
a process of, if the type of the conflict is a same mutual direction conflict or a node conflict, or the conflict node is not the end node, comparing the time of the current AGV entering the conflict node in the previous task with the time of the current AGV entering the conflict node in the current task to assign priorities;
a process of, after the priorities are assigned or the priority of the current task at the conflict node is modified to the low priority, modifying a time window information table;
a process of, as the time window information table is modified, or no conflict is detected, determining whether the current task has been completely compared with scheduled tasks; and
a process of, if the current task has been completely compared with the scheduled tasks, driving the current AGV to perform the current task.

12. The non-transitory computer-readable storage medium of claim 11, wherein the step of driving the current AGV to perform the current task further comprises:
a process of driving the current AGV to move from a node m to the next node n;
a process of determining whether there is an obstacle between the node m the and the node n;
a process of, if there is an obstacle between the node m and the node n, enabling the current AGV to stop and wait for a preset time, and determining whether the obstacle is cleared;
a process of, if there is no obstacle between the node m and the node n, determining whether the current AGV is malfunctioning;
a process of, if the current AGV is malfunctioning, enabling the current AGV to stop and wait for the preset time, and determining whether the malfunctioning state is removed; and
a process of, if the obstacle is not cleared, or if the malfunctioning state is not removed, updating the time window information table and re-planning the path at a current position of the current AGV.

13. The non-transitory computer-readable storage medium of claim 12, wherein the step of driving the current AGV to perform the current task further comprises:
a process of, if the current AGV is not malfunctioning, determining whether a distance between the current AGV and the node n is less than a preset distance;
a process of, if the distance between the current AGV and the node n is not less than the preset distance, enabling the current AGV to keep moving forward and reducing the distance between the current position and the node n by a second preset distance;
a process of, if the distance between the current AGV and the node n is less than the preset distance, determining whether the node n is occupied or has a lower priority;
a process of, if the node n is occupied or has a lower priority, enabling the current AGV to park and wait according to the time window information table;
a process of, if the node n is not occupied or does not have a lower priority, enabling the current AGV to keep moving forward and determining whether the current AGV has reached the node n;
a process of, if the current AGV has reached the node n, updating operation information report and m=n that the node n serves as the current node;
a process of determining whether the current AGV has reached a target workstation; and
a process of, if the current AGV has reached the target workstation, modifying and updating the time window information table and terminating the current task.

14. The non-transitory computer-readable storage medium of claim 11, further comprising:
a process of, if the end node of the current path is occupied with mutual occupation, selecting another path from the paths as the current path.

15. The non-transitory computer-readable storage medium of claim 11, further comprising:
a process of calculating all the possible paths of the current AGV using the A* search algorithm.
